(19) United States
(12) Patent Application Publication
(10) Pub. No.: US 2019/0155006 A1
(43) Pub. Date: May 23, 2019

(54) OPTICAL WIDE ANGLE LENS

(71) Applicant: SUNNY OPTICAL OVERSEAS LIMITED, Taipei City (TW)

(72) Inventors: Tzu-Yuan Lin, Taichung City (TW); Sheng-Lung Lin, Taichung City (TW); Leit Ho, Taichung City (TW)

(73) Assignee: SUNNY OPTICAL OVERSEAS LIMITED, Taipei City (TW)

(21) Appl. No.: 15/821,278

(22) Filed: Nov. 22, 2017

(51) Int. Cl. G02B 15/177; G02B 13/06; G02B 13/00; G02B 9/62

(52) U.S. Cl. CPC G02B 15/177; G02B 9/62; G02B 13/0045; G02B 13/06

(57) ABSTRACT

A wide angle optical lens assembly includes a first lens group and a second lens group arranged in order from an object side to an image plane along an optical axis, satisfying the following condition: 2.0≤|F1/EFL|≤3.65; 2.6≤|F2/EFL|≤3.45; wherein, EFL is effective focal length of the wide angle optical lens assembly; F1 is effective focal length of the first lens group; F2 is effective focal length of the second lens group. The first lens group includes a first lens having negative refractive power, a second lens having negative refractive power, and a third lens having positive refractive power arranged in order from the object side. The second lens is a meniscus lens, having a convex image-side surface. The second lens group includes a fourth lens having positive refractive power, a fifth lens having negative refractive power, and a sixth lens having positive refractive power arranged in order from the object side.

### BACKGROUND OF THE INVENTION

### 1. Technical Field

The present invention is related to an optical lens, and more particularly to a wide angle optical lens which can be made with a small size and a wide angle of view, of which the total length is short.

### 2. Description of Related Art

With the development of the electronic device technology, such as CCD and CMOS, electronic devices are manufactured in pursuit of better portability. Therefore, there is a need for the manufacturers to develop a camera or lens assembly capable of providing wide angle of view, reducing the weight, enabling the miniaturization, and also providing higher image quality.

However, conventional lens assembly cannot provide a wide angle of view and low distortion of optical performance when reducing the size of the lens assembly. In all aspects, the conventional lens assembly still has room for improvements.

### BRIEF SUMMARY OF THE INVENTION

In view of the above, an object of the present invention is to provide a wide angle optical lens which can be made with a low distortion, a small size and a wide angle of view, of which the total length is short.

Therefore, the present invention provides a wide angle optical lens assembly which includes, in order from an object side to an image plane along an optical axis, a first lens group and a second lens group. The first lens group includes a first lens, a second lens, and a third lens arranged in order from the object side to the image plane along the optical axis, wherein the first lens has negative refractive power; the second lens has negative refractive power, and is a meniscus lens, having a convex surface facing the image plane; the third lens has positive refractive power. The second lens group includes a fourth lens, a fifth lens, and a sixth lens arranged in order from the object side to the image plane along the optical axis, wherein the fourth lens has positive refractive power, the fifth lens has negative refractive power, and the sixth lens has positive refractive power. The wide angle optical lens assembly satisfies the following condition: 2.0≤|F1/EFL|≤3.65; 2.6≤F2|EFL|≤3.45; where EFL is an effective focal length of the wide angle optical lens assembly, F1 is the effective focal length of the first lens group, and F2 is the effective focal length of the second lens group.

With the design of the optical configuration and the distribution of the refractive powers of the lenses, the wide angle optical lens could provide a wide angle of view, could be made with a small size, and could be lightweight, of which the total length is short.

### BRIEF DESCRIPTION OF THE SEVERAL VIEWS OF THE DRAWINGS

The present invention will be best understood by referring to the following detailed description of some illustrative embodiments in conjunction with the accompanying drawings, in which

FIG. 1 is a schematic view of a wide angle optical lens of a first embodiment of the present invention;

FIG. 2 is a diagram showing a longitudinal spherical aberration of the wide angle optical lens of the first embodiment of the present invention;

FIG. 3 is a diagram showing astigmatic field curves of the wide angle optical lens of the first embodiment of the present invention;

FIG. 4 is a diagram showing distortion of the wide angle optical lens of the first embodiment of the present invention;

FIG. 5 is a diagram showing lateral color aberration of the wide angle optical lens of the first embodiment of the present invention;

FIG. 6 is a schematic view of a wide angle optical lens of a second embodiment of the present invention;

FIG. 7 is a diagram showing a longitudinal spherical aberration of the wide angle optical lens of the second embodiment of the present invention;

FIG. 8 is a diagram showing astigmatic field curves of the wide angle optical lens of the second embodiment of the present invention;

FIG. 9 is a diagram showing distortion of the wide angle optical lens of the second embodiment of the present invention;

FIG. 10 is a diagram showing lateral color aberration of the wide angle optical lens of the second embodiment of the present invention;

FIG. 11 is a schematic view of a wide angle optical lens of a third embodiment of the present invention;

FIG. 12 is a diagram showing a longitudinal spherical aberration of the wide angle optical lens of the third embodiment of the present invention;

FIG. 13 is a diagram showing astigmatic field curves of the wide angle optical lens of the third embodiment of the present invention;

FIG. 14 is a diagram showing distortion of the wide angle optical lens of the third embodiment of the present invention;

FIG. 15 is a diagram showing lateral color aberration of the wide angle optical lens of the third embodiment of the present invention;

FIG. 16 is a schematic view of a wide angle optical lens of a fourth embodiment of the present invention;

FIG. 17 is a diagram showing a longitudinal spherical aberration of the wide angle optical lens of the fourth embodiment of the present invention;

FIG. 18 is a diagram showing astigmatic field curves of the wide angle optical lens of the fourth embodiment of the present invention;

FIG. 19 is a diagram showing distortion of the wide angle optical lens of the fourth embodiment of the present invention;

FIG. 20 is a diagram showing lateral color aberration of the wide angle optical lens of the fourth embodiment of the present invention;

FIG. 21 is a schematic view of a wide angle optical lens of a fifth embodiment of the present invention;

FIG. 22 is a diagram showing a longitudinal spherical aberration of the wide angle optical lens of the fifth embodiment of the present invention;

FIG. 23 is a diagram showing astigmatic field curves of the wide angle optical lens of the fifth embodiment of the present invention;

FIG. 24 is a diagram showing distortion of the wide angle optical lens of the fifth embodiment of the present invention; and

FIG. 25 is a diagram showing lateral color aberration of the wide angle optical lens of the fifth embodiment of the present invention.

### DETAILED DESCRIPTION OF THE INVENTION

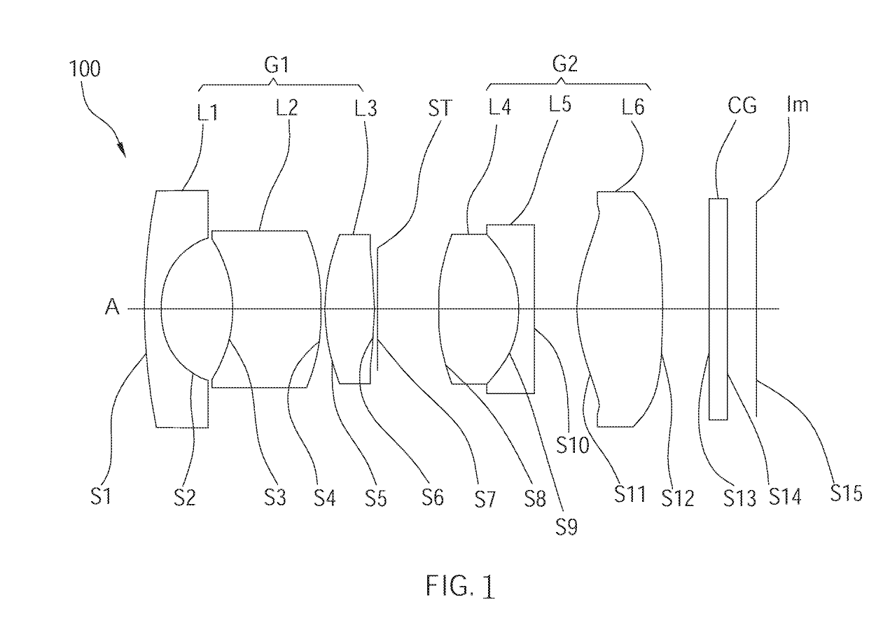

A wide angle optical lens assembly 100 of a first embodiment of the present invention is illustrated in FIG. 1, wherein the wide angle optical lens assembly 100 of the first embodiment includes a first lens group G1 and a second lens group G2 arranged in order from an object side to an image plane Im along an optical axis A.

In the current embodiment, an effective focal length of the first lens group G1 is positive. The first lens group G1 includes a first lens L1, a second lens L2, and a third lens L3, which are arranged in order from the object side to the image plane Im along the optical axis A, wherein the first lens L1 has negative refractive power, the second lens L2 has negative refractive power, and the third lens L3 has positive refractive power. In the current embodiment, the first lens L1 is a meniscus lens, having a convex surface S1 facing the object side and a concave surface S2 facing the image plane Im; the second lens L2 is a meniscus lens, having a concave surface S3 facing the object side and a convex surface S4 facing the image plane Im; the third lens L3 is a biconvex lens.

In the current embodiment, an effective focal length of the second lens group G2 is positive. The second lens group G2 includes a fourth lens L4, a fifth lens L5, and a sixth lens L6, which are arranged in order from the object side to the image plane Im along the optical axis A, wherein the fourth lens L4 has positive refractive power, the fifth lens L5 has negative refractive power, and the sixth lens L6 has positive refractive power. In the current embodiment, the fourth lens L4 is a biconvex lens; the fifth lens L5 is a biconcave lens, having a concave surface S9 facing the object side, i.e, an object-side surface, and a concave surface S10 facing the image plane Im, i.e, an image-side surface; the sixth lens L6 is a biconvex lens. The object-side surface of the fifth lens L5 and an image-side surface of the fourth lens L4 are adhered together to form a doublet lens. At least one of the surfaces of the sixth lens L6 is aspheric. Preferably, both the object-side surface and the image-side surface of the sixth lens L6 are aspheric.

Preferably, said first lens L1 to said sixth lens L6 are made of glass, and the sixth lens L6 is a molded aspheric lens, whereby to reduce the aberration of the wide angle optical lens assembly 100, and the number of the lens elements can be reduced so as to minimize the total track length thereof. In addition, a stop ST is disposed between the first lens group G1 and the second lens group G2. Preferably, the stop ST is close to the third lens L3 rather than to the fourth lens L4. Moreover, a filter CG can be disposed between the sixth lens L6 and the image plane Im to filter out noise light signal, whereby to improve the optical efficiency of the wide angle optical lens assembly 100.

Said wide angle optical lens assembly 100 of the first embodiment further satisfies the following condition: 2.0≤|F1/EFL|≤3.65; 2.6≤|F2/EFL|≤3.45. Preferably, the wide angle optical lens assembly 100 satisfies the following condition: 2.2≤|F1/EFL|≤3.0; 2.8≤|F2/EFL|≤3.15; where EFL is an effective focal length of the wide angle optical lens assembly 100, F1 is the effective focal length of the first lens groupfirst lens group G1, F2 is the effective focal length of the second lens group G2. With the aforementioned design, the wide angle optical lens assembly 100 could have a wide angle of view, could be made with a small size, and could be lightweight, of which the total length is short.

Preferably, said wide angle optical lens assembly 100 of the first embodiment further satisfies the following condition: Nd4≤1.5; Vd4>70; Nd5>1.7; Vd5≤35; where Nd4 is a refractive index of the fourth lens L4, Vd4 is a dispersion coefficient of the fourth lens L4; Nd5 is a refractive index of the fifth lens L5, Vd5 is a dispersion coefficient of the fifth lens L5. With the aforementioned design regarding the refractive indexes Nd4, Nd5 and the dispersion coefficients Vd4, Vd5 of the fourth lens L4 and the fifth lens L5, the longitudinal chromatic aberration of the wide angle optical lens assembly 100 could be further minimized, providing a better performance balance.

The parameters of the lenses of the wide angle optical lens assembly 100 of the first embodiment of the present invention are shown in Table 1, wherein F1=7.261 mm; F2=8.624 mm; EFL=2.917 mm; F-number=2.0; TTL=18.5 mm; F1/EFL=2.4892; F2/EFL=2.9564; where TTL is the total track length of the wide angle optical lens assembly 100 (i.e., a distance on the optical axis A from the surface S1 of the first lens L1 which faces the object side to the image plane Im); the units of the curvature radius, the thickness, the distance and the focal length are expressed in mm; surfaces 0 to S15 respectively represents the surfaces of the lenses in order from the object side to the image plane Im.

TABLE 1
First Embodiment

| | | | | Refrac- | | |
|---|---|---|---|---|---|---|
| | | Radius of | Thick- | tive | Abbe | Focal |
| | | curvature | ness | index, | number, | Length |
| | Suface# | (mm) | (mm) | Nd | Vd | (mm) |
| Object | 0 | Plano | Infinity | | | |
| L1 | S1 | 17.123 | 0.500 | 1.744 | 44.9 | −3.688 |
| | S2 | 2.346 | 2.161 | | | |
| L2 | S3 | −4.103 | 2.706 | 1.772 | 49.6 | −27.320 |
| | S4 | −6.553 | 0.100 | | | |
| L3 | S5 | 6.242 | 1.498 | 1.700 | 48.1 | 6.115 |
| | S6 | −12.470 | 0.100 | | | |
| STOP | S7 | Plano | 1.836 | | | |
| L4 | S8 | 6.152 | 2.390 | 1.496 | 81.6 | 4.585 |
| L5 | S9 | −3.167 | 0.500 | 1.784 | 26.1 | −3.986 |
| | S10 | 1006.307 | 1.313 | | | |
| L6 | S11 | 4.547(ASP) | 2.574 | 1.496 | 81.6 | 7.491 |
| | S12 | −16.957(ASP) | 1.424 | | | |
| CG | S13 | Plano | 0.500 | 1.516 | 64.1 | — |
| | S14 | Plano | 0.900 | | | |
| Image | S15 | Plano | — | | | |

The aspheric coefficients of each of the lenses of the wide angle optical lens assembly 100 of the first embodiment of the present invention are shown in Table 2; where K is the conic coefficient of the equation of the aspheric surface profile; A4 to A10 are aspheric coefficients of each of the surfaces of the sixth lens L6.

TABLE 2
Aspheric Coefficients

Surface#

| | S11 | S12 |
|---|---|---|
| K = | −5.97290E+00 | 1.83328E+01 |
| A4 = | 3.32230E−03 | −2.86617E−04 |
| A6 = | −5.98124E−04 | −1.13781E−04 |
| A8 = | 3.95712E−05 | −5.52670E−06 |
| A10 = | −2.58803E−06 | 5.47166E−08 |

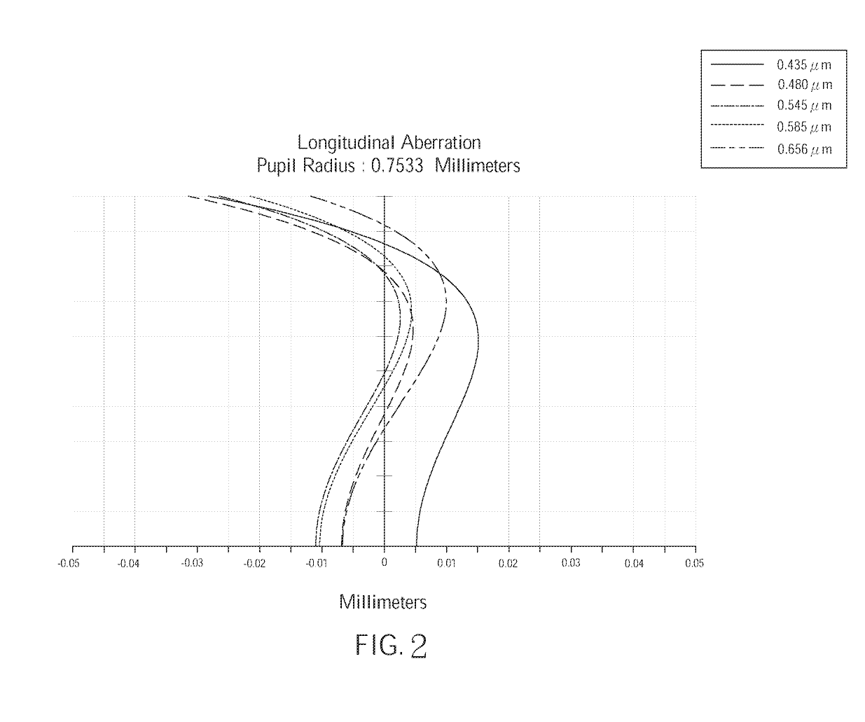

FIG. 2 is a diagram showing a longitudinal spherical aberration of the wide angle optical lens assembly 100 of the first embodiment of the present invention. As shown in FIG. 2, the longitudinal spherical aberration of the wide angle optical lens assembly 100 of the first embodiment corresponding to the light having wavelengths of 0.435 μm, 0.480 μm, 0.545 μm, 0.585 μm, and 0.656 μm is within a range of −0.035 mm to 0.015 mm Hence, in the current embodiment, the longitudinal spherical aberration of the lens assembly is improved.

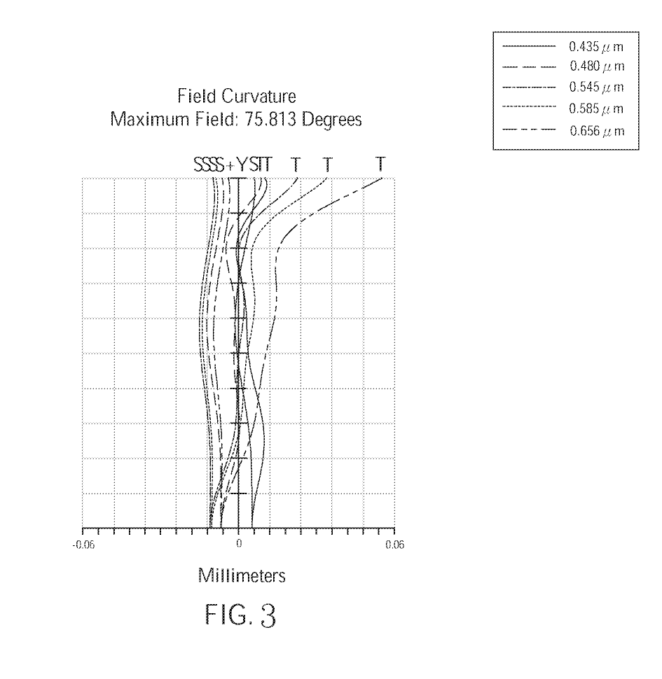

FIG. 3 is a diagram showing astigmatic field curves of the wide angle optical lens assembly 100 of the first embodiment of the present invention. As shown in FIG. 3, the field curvature of the wide angle optical lens assembly 100 of the first embodiment corresponding to the light having wavelengths of 0.435 μm, 0.480 μm, 0.545 μm, 0.585 μm, and 0.656 μm in the tangential direction and the sagittal direction is respectively within a range of −0.018 mm to 0.06 mm Hence, in the current embodiment, the astigmatic could be effectively corrected.

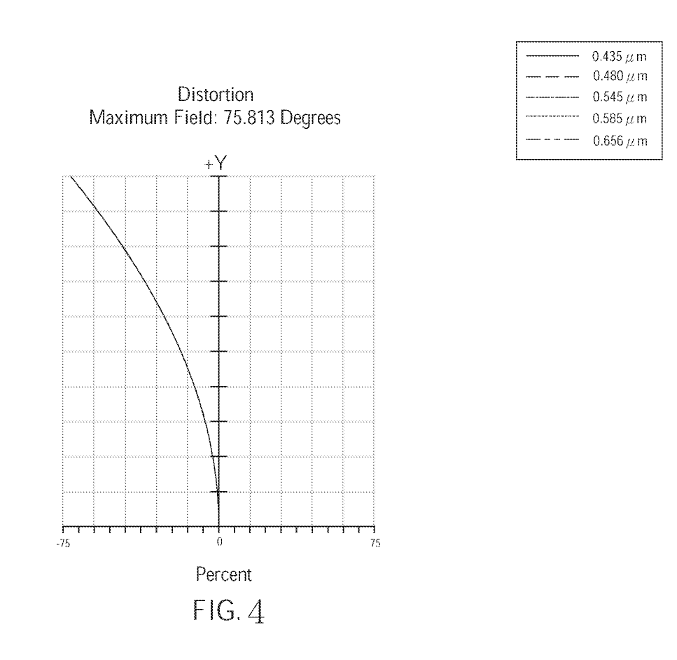

FIG. 4 is a diagram showing distortion of the wide angle optical lens assembly 100 of the first embodiment of the present invention. As shown in FIG. 4, the distortion of the wide angle optical lens assembly 100 of the first embodiment corresponding the light having wavelengths of 0.435 μm, 0.480 μm, 0.545 μm, 0.585 μm, and 0.656 μm is within the range of −75%. Hence, the distortion of the wide angle optical lens assembly 100 of the current embodiment could be effectively corrected.

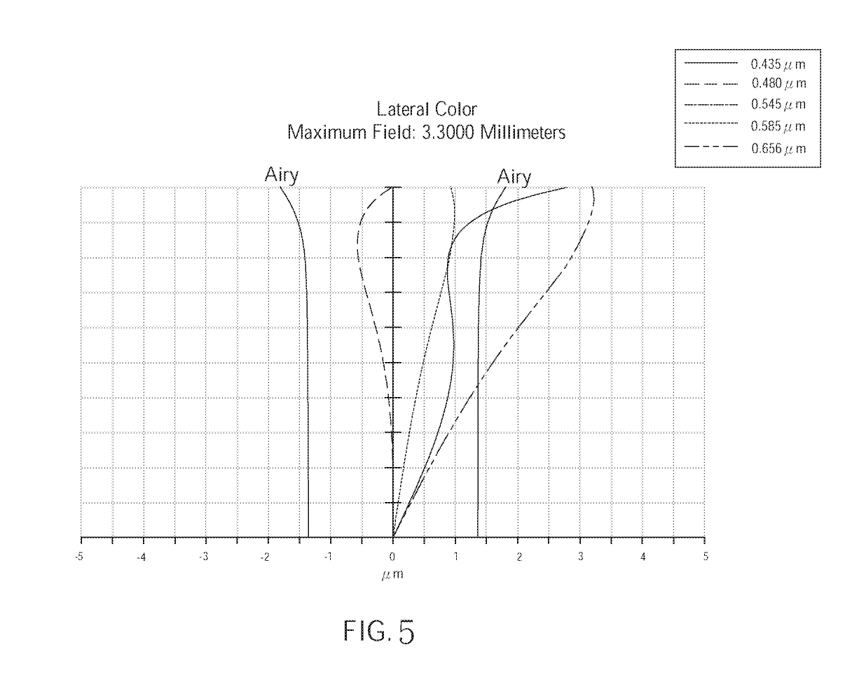

FIG. 5 is a diagram showing lateral color aberration of the wide angle optical lens assembly 100 of the first embodiment of the present invention. As shown in FIG. 5, the lateral color aberration of the wide angle optical lens assembly 100 of the first embodiment corresponding to the light having wavelengths of 0.435 μm, 0.480 μm, 0.545 μm, 0.585 μm, and 0.656 μm is generally within the range of the Airy disk radius. Hence, the lateral color aberration of the wide angle optical lens assembly 100 of the current embodiment could be effectively corrected.

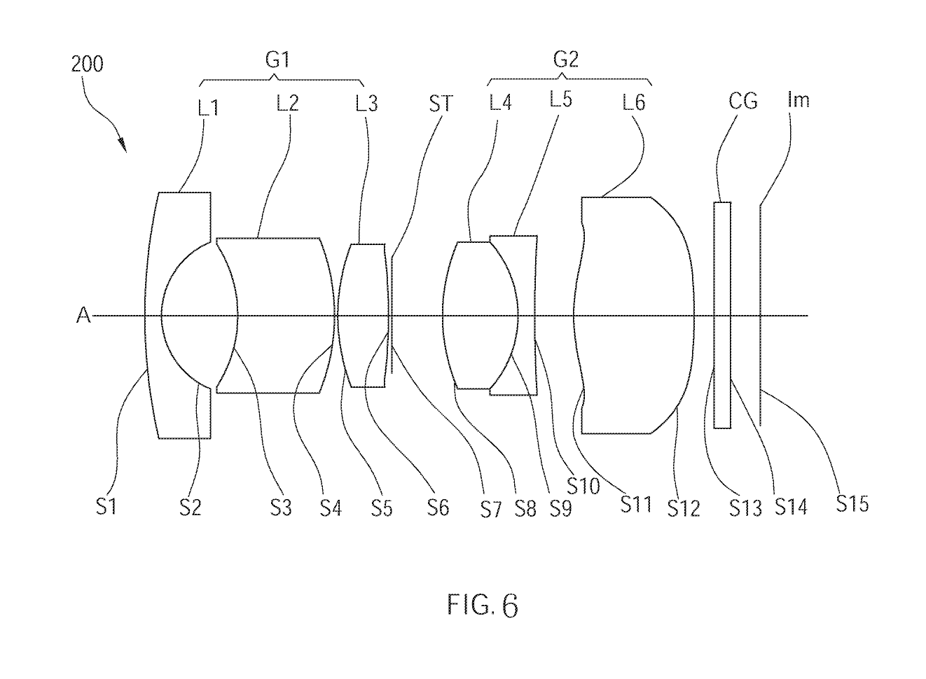

A wide angle optical lens assembly 200 of a second embodiment of the present invention is illustrated in FIG. 6, which has almost the same structure as the wide angle optical lens assembly 100 of the first embodiment, wherein the wide angle optical lens assembly 200 of the second embodiment includes a first lens group G1 and a second lens group G2 arranged in order from an object side to an image plane Im along an optical axis A.

In the current embodiment, an effective focal length of the first lens group G1 is positive. The first lens group G1 includes a first lens L1, a second lens L2, and a third lens L3, which are arranged in order from the object side to the image plane Im along the optical axis A, wherein the first lens L1 has negative refractive power, the second lens L2 has negative refractive power, and the third lens L3 has positive refractive power. In the current embodiment, the first lens L1 is a meniscus lens, having a convex surface S1 facing the object side and a concave surface S2 facing the image plane Im; the second lens L2 is a meniscus lens, having a concave surface S3 facing the object side and a convex surface S4 facing the image plane Im; the third lens L3 is a biconvex lens.

In the current embodiment, an effective focal length of the second lens group G2 is positive. The second lens group G2 includes a fourth lens L4, a fifth lens L5, and a sixth lens L6, which are arranged in order from the object side to the image plane Im along the optical axis A, wherein the fourth lens L4 has positive refractive power, the fifth lens L5 has negative refractive power, and the sixth lens L6 has positive refractive power. In the current embodiment, the fourth lens L4 is a biconvex lens; the fifth lens L5 is a biconcave lens, having a concave surface S9 facing the object side, i.e, an object-side surface, and a concave surface S10 facing the image plane Im, i.e, an image-side surface; the sixth lens L6 is a biconvex lens. The object-side surface of the fifth lens L5 and an image-side surface of the fourth lens L4 are adhered together to form a doublet lens. In the current embodiment, both the object-side surface and the image-side surface of the sixth lens L6 are aspheric. The sixth lens L6 is a molded aspheric lens, whereby to reduce the aberration of the wide angle optical lens assembly 200, and the number of the lens elements can be reduced so as to minimize the total track length thereof. In addition, a stop ST can be disposed between the first lens group G1 and the second lens group G2, and a filter CG can be disposed between the sixth lens L6 and the image plane Im.

Said wide angle optical lens assembly 200 of the second embodiment further satisfies the following condition: 2.0≤|F1/EFL|≤3.65; 2.6≤|F2/EFL|≤3.45. With the aforementioned design, said wide angle optical lens assembly 200 could have a wide angle of view, could be made with a small size, and could be lightweight, of which the total length is short. Preferably, said wide angle optical lens assembly 200 further satisfies the following condition: Nd4<1.5; Vd4>70; Nd5>1.7; and Vd5<35, where Nd4 is a refractive index of the fourth lens L4, Vd4 is a dispersion coefficient of the fourth lens L4; Nd5 is a refractive index of the fifth lens L5, Vd5 is a dispersion coefficient of the fifth lens L5. With the aforementioned design regarding the refractive indexes Nd4, Nd5 and the dispersion coefficients Vd4, Vd5 of the fourth lens L4 and the fifth lens L5, the longitudinal chromatic aberration of the wide angle optical lens assembly 200 could be further minimized, providing a better performance balance.

The parameters of the lenses of the wide angle optical lens assembly 200 of the second embodiment of the present invention are shown in Table 3, wherein F1=5.910 mm; F2=10.161 mm; EFL=2.945 mm; F-number=2.2; TTL=18.5 mm; F1/EFL=2.0067; and F2/EFL=3.4502; where TTL is the total track length of the wide angle optical lens assembly 200 (i.e., a distance on the optical axis A from the surface S1 of the first lens L1 which faces the object side to the image plane Im); the units of the curvature radius, the thickness, the distance and the focal length are expressed in mm; surfaces 0 to S15 respectively represents the surfaces of the lenses in order from the object side to the image plane Im.

TABLE 3
Second embodiment

| | | | | Refrac- | | |
|---|---|---|---|---|---|---|
| | | Radius of | Thick- | tive | Abbe | Focal |
| | | curvature | ness | index, | number, | Length |
| | Suface# | (mm) | (mm) | Nd | Vd | (mm) |
| Object | 0 | Plano | Infinity | | | |
| L1 | S1 | 16.492 | 0.500 | 1.747 | 51.0 | −3.794 |
| | S2 | 2.397 | 2.293 | | | |
| L2 | S3 | −3.941 | 2.906 | 1.694 | 53.3 | −34.563 |
| | S4 | −6.138 | 0.100 | | | |
| L3 | S5 | 5.912 | 1.524 | 1.713 | 53.9 | 6.121 |
| | S6 | −15.138 | 0.100 | | | |
| STOP | S7 | Plano | 1.523 | | | |
| L4 | S8 | 5.590 | 2.267 | 1.496 | 81.6 | 4.560 |
| L5 | S9 | −3.314 | 0.500 | 1.784 | 26.1 | −3.861 |
| | S10 | 42.180 | 1.171 | | | |
| L6 | S11 | 5.259(ASP) | 3.623 | 1.496 | 81.6 | 8.507 |
| | S12 | −16.879(ASP) | 0.593 | | | |
| CG | S13 | Plano | 0.500 | 1.516 | 64.1 | — |
| | S14 | Plano | 0.900 | | | |
| Image | S15 | Plano | — | | | |

The aspheric coefficients of each of the lenses of the wide angle optical lens assembly 200 of the second embodiment of the present invention are shown in Table 4; where K is the conic coefficient of the equation of the aspheric surface profile; A4 to A10 are aspheric coefficients of each of the surfaces of the sixth lens L6.

TABLE 4
Aspheric Coefficients

Surface#

| | S1 | S2 |
|---|---|---|
| K = | −8.10301E+00 | 1.73744E+01 |
| A4 = | 5.98152E−04 | −3.02970E−03 |
| A6 = | −7.46466E−04 | −3.04504E−04 |
| A8 = | 5.13035E−05 | 1.63496E−05 |
| A10 = | −6.23036E−06 | −3.52152E−07 |

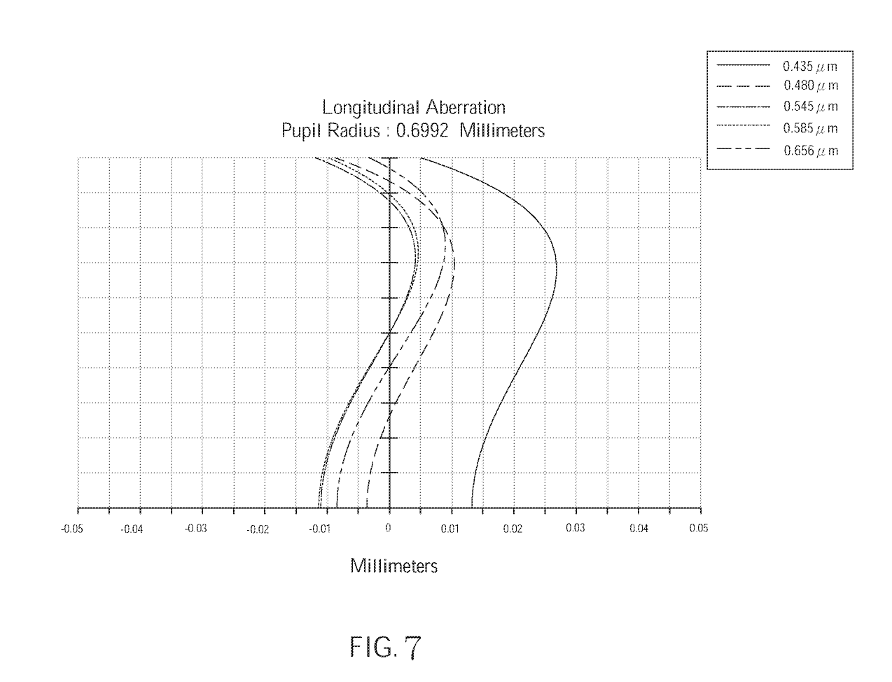

FIG. 7 to FIG. 10 are diagrams showing longitudinal spherical aberration, astigmatic field curves, distortion, and lateral color aberration of the wide angle optical lens assembly 200 of the second embodiment of the present invention.

As shown in FIG. 7, the longitudinal spherical aberration of the wide angle optical lens assembly 200 of the second embodiment corresponding to the light having wavelengths of 0.435 μm, 0.480 μm, 0.545 μm, 0.585 μm, and 0.656 μm is within a range of −0.015 mm to 0.03 mm Hence, in the current embodiment, the longitudinal spherical aberration of the lens assembly is improved.

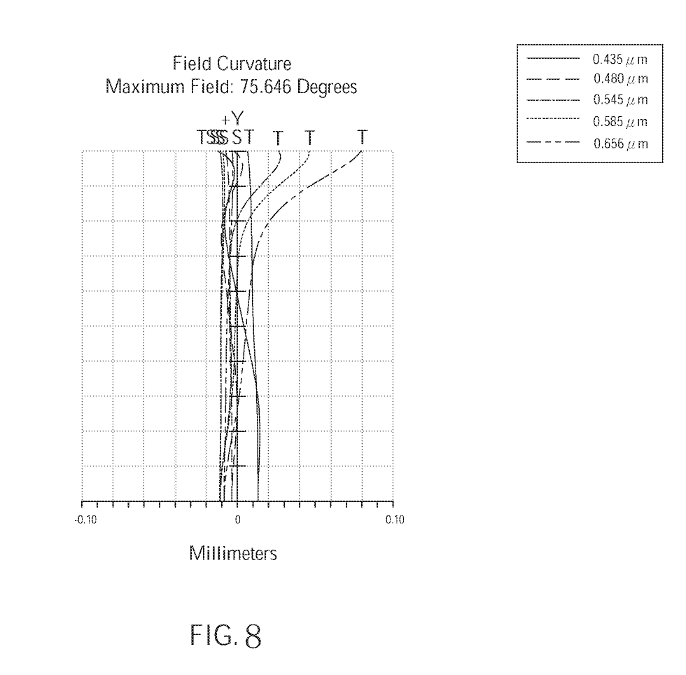

As shown in FIG. 8, the field curvature of the wide angle optical lens assembly 200 of the second embodiment corresponding to the light having wavelengths of 0.435 μm, 0.480 μm, 0.545 μm, 0.585 μm, and 0.656 μm in the tangential direction and the sagittal direction is respectively within a range of −0.02 mm to 0.08 mm Hence, in the current embodiment, the astigmatic can be effectively corrected.

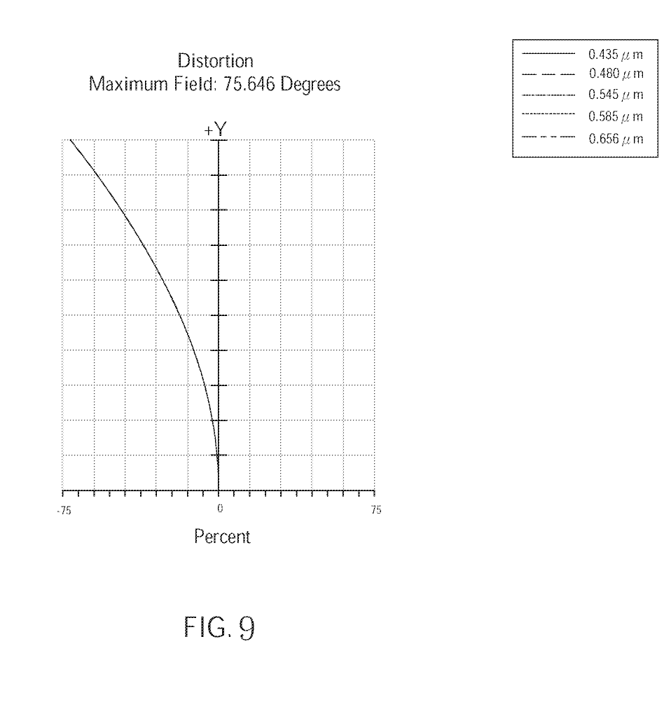

As shown in FIG. 9, the distortion of the wide angle optical lens assembly 200 of the second embodiment corresponding the light having wavelengths of 0.435 μm, 0.480 μm, 0.545 μm, 0.585 μm, and 0.656 μm is within the range of −75%. Hence, the distortion of the wide angle optical lens assembly 200 of the current embodiment could be effectively corrected.

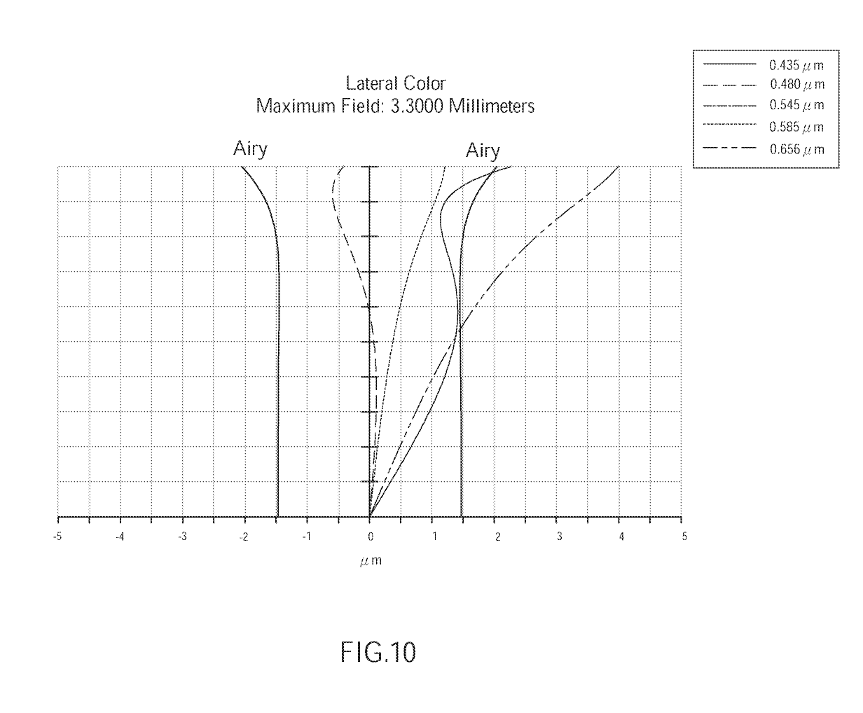

As shown in FIG. 10, the lateral color aberration of the wide angle optical lens assembly 200 of the second embodiment corresponding to the light having wavelengths of 0.435 μm, 0.480 μm, 0.545 μm, 0.585 μm, and 0.656 μm is generally within the range of the Airy disk radius. Hence, the lateral color aberration of the wide angle optical lens assembly 200 of the current embodiment could be effectively corrected.

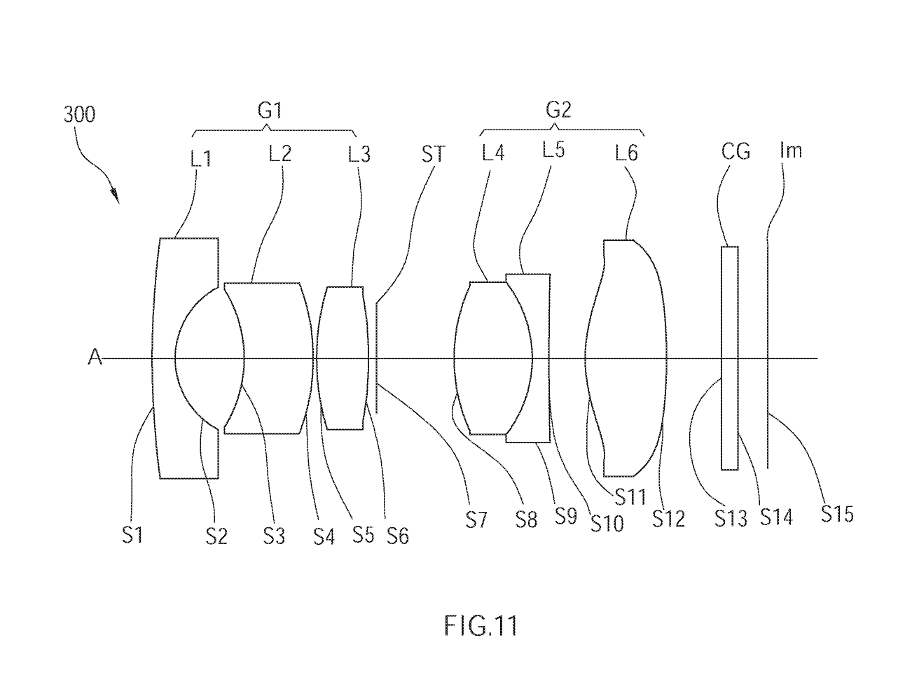

A wide angle optical lens assembly 300 of a third embodiment of the present invention is illustrated in FIG. 11, which has almost the same structure as the wide angle optical lens assembly 100 of the first embodiment, wherein the wide angle optical lens assembly 300 of the third embodiment includes a first lens group G1 and a second lens group G2 arranged in order from an object side to an image plane Im along an optical axis A.

In the current embodiment, an effective focal length of the first lens group G1 is positive. The first lens group G1 includes a first lens L1, a second lens L2, and a third lens L3, which are arranged in order from the object side to the image plane Im along the optical axis A, wherein the first lens L1 has negative refractive power, the second lens L2 has negative refractive power, and the third lens L3 has positive refractive power. In the current embodiment, the first lens L1 is a meniscus lens, having a convex surface S1 facing the object side and a concave surface S2 facing the image plane Im; the second lens L2 is a meniscus lens, having a concave surface S3 facing the object side and a convex surface S4 facing the image plane Im; the third lens L3 is a biconvex lens.

In the current embodiment, an effective focal length of the second lens group G2 is positive. The second lens group G2 includes a fourth lens L4, a fifth lens L5, and a sixth lens L6, which are arranged in order from the object side to the image plane Im along the optical axis A, wherein the fourth lens L4 has positive refractive power, the fifth lens L5 has negative refractive power, and the sixth lens L6 has positive refractive power. In the current embodiment, the fourth lens L4 is a biconvex lens; the fifth lens L5 is a biconcave lens, having a concave surface S9 facing the object side, i.e, an object-side surface, and a concave surface S10 facing the image plane Im, i.e, an image-side surface; the sixth lens L6 is a biconvex lens. The object-side surface of the fifth lens L5 and an image-side surface of the fourth lens L4 are adhered together to form a doublet lens. In the current embodiment, both the object-side surface and the image-side surface of the sixth lens L6 are aspheric. The sixth lens L6 is a molded aspheric lens, whereby to reduce the aberration of the wide angle optical lens assembly 300, and the number of the lens elements can be reduced so as to minimize the total track length thereof. In addition, a stop ST can be disposed between the first lens group G1 and the second lens group G2, and a filter CG can be disposed between the sixth lens L6 and the image plane Im.

Said wide angle optical lens assembly 300 of the third embodiment further satisfies the following condition: 2.0≤|F1/EFL|≤3.65; 2.6≤|F2/EFL|≤3.45. With the aforementioned design, said wide angle optical lens assembly 300 could have a wide angle of view, could be made with a small size, and could be lightweight, of which the total length is short. Preferably, said wide angle optical lens assembly 300 further satisfies the following condition: Nd4<1.5; Vd4>70; Nd5>1.7; and Vd5<35, where Nd4 is a refractive index of the fourth lens L4, Vd4 is a dispersion coefficient of the fourth lens L4; Nd5 is a refractive index of the fifth lens L5, Vd5 is a dispersion coefficient of the fifth lens L5. With the aforementioned design regarding the refractive indexes Nd4, Nd5 and the dispersion coefficients Vd4, Vd5 of the fourth lens L4 and the fifth lens L5, the longitudinal chromatic aberration of the wide angle optical lens assembly 300 could be further minimized, providing a better performance balance.

The parameters of the lenses of the wide angle optical lens assembly 300 of the third embodiment of the present invention are shown in Table 5, wherein F1=10.899 mm; F2=7.819 mm; EFL=3.007 mm; F-number=2.2; TTL=18.5 mm; F 1/EFL=3.6245; F2/EFL=2.6002; where TTL is the total track length of the wide angle optical lens assembly 300 (i.e., a distance on the optical axis A from the surface S1 of the first lens L1 which faces the object side to the image plane Im); the units of the curvature radius, the thickness, the distance and the focal length are expressed in mm; surfaces 0 to S15 respectively represents the surfaces of the lenses in order from the object side to the image plane Im.

TABLE 5
Third embodiment

| | | | | Refrac- | | |
|---|---|---|---|---|---|---|
| | | Radius of | Thick- | tive | Abbe | Focal |
| | | curvature | ness | index, | number, | Length |
| | Suface# | (mm) | (mm) | Nd | Vd | (mm) |
| Object | 0 | Plano | Infinity | | | |
| L1 | S1 | 27.380 | 0.690 | 1.744 | 44.9 | −3.589 |
| | S2 | 2.419 | 2.073 | | | |
| L2 | S3 | −3.938 | 2.078 | 1.772 | 49.6 | −22.477 |
| | S4 | −6.258 | 0.100 | | | |
| L3 | S5 | 7.319 | 1.563 | 1.743 | 49.2 | 6.010 |
| | S6 | −10.553 | 0.240 | | | |
| STOP | S7 | Plano | 2.328 | | | |
| L4 | S8 | 5.256 | 2.347 | 1.496 | 81.6 | 4.802 |
| L5 | S9 | −3.743 | 0.500 | 1.784 | 26.1 | −4.536 |
| | S10 | 94.794 | 1.094 | | | |
| L6 | S11 | 4.626(ASP) | 2.441 | 1.496 | 81.6 | 7.610 |
| | S12 | −17.375(ASP) | 1.648 | | | |
| CG | S13 | Plano | 0.500 | 1.516 | 64.1 | — |
| | S14 | Plano | 0.900 | | | |
| Image | S15 | Plano | — | | | |

The aspheric coefficients of each of the lenses of the wide angle optical lens assembly 300 of the third embodiment of the present invention are shown in Table 6; where K is the conic coefficient of the equation of the aspheric surface profile; A4 to A10 are aspheric coefficients of each of the surfaces of the sixth lens L6.

TABLE 6
Aspheric Coefficients

Surface#

| | S1 | S2 |
|---|---|---|
| K = | −5.45925E+00 | 2.00000E+01 |
| A4 = | 2.24922E−03 | −7.00339E−05 |
| A6 = | −5.30301E−04 | −1.80596E−04 |
| A8 = | 3.30016E−05 | −3.03013E−06 |
| A10 = | −2.69897E−06 | −3.79316E−08 |

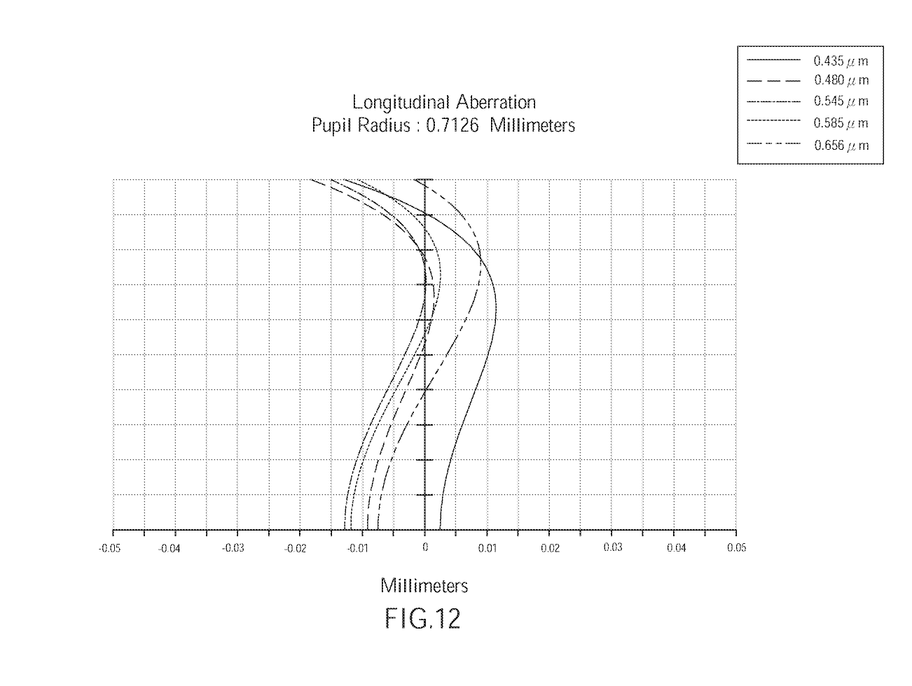

FIG. 12 to FIG. 15 are diagrams showing longitudinal spherical aberration, astigmatic field curves, distortion, and lateral color aberration of the wide angle optical lens assembly 300 of the third embodiment of the present invention.

As shown in FIG. 12, the longitudinal spherical aberration of the wide angle optical lens assembly 300 of the third embodiment corresponding to the light having wavelengths of 0.435 μm, 0.480 μm, 0.545 μm, 0.585 μm, and 0.656 μm is within a range of -0.02 mm to 0.02 mm. Hence, in the current embodiment, the longitudinal spherical aberration of the lens assembly is improved.

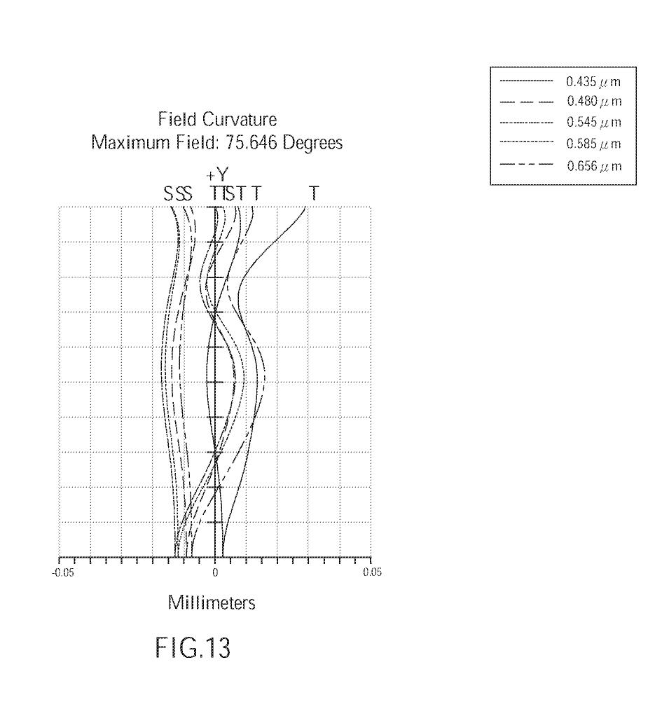

As shown in FIG. 13, the field curvature of the wide angle optical lens assembly 300 of the third embodiment corresponding to the light having wavelengths of 0.435 μm, 0.480 μm, 0.545 μm, 0.585 μm, and 0.656 μm in the tangential direction and the sagittal direction is respectively within a range of −0.02 mm to 0.03 mm Hence, in the current embodiment, the astigmatic can be effectively corrected.

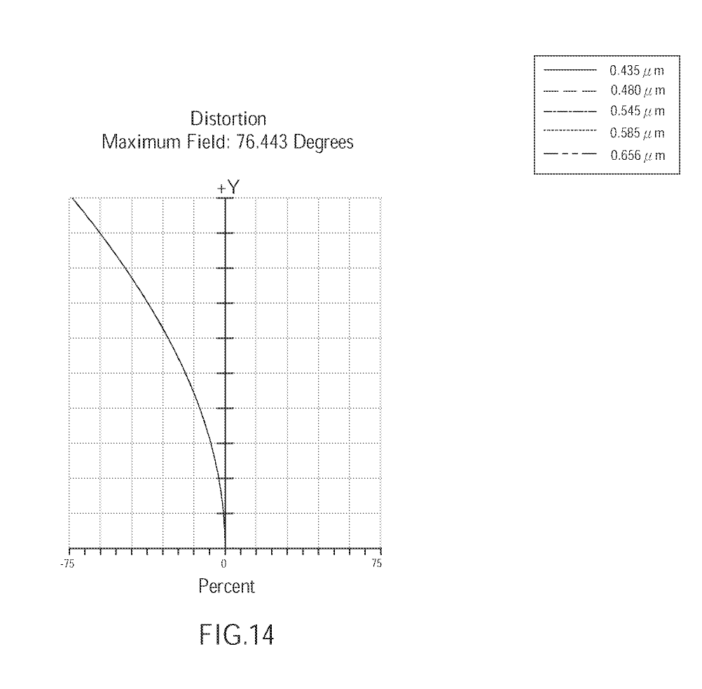

As shown in FIG. 14, the distortion of the wide angle optical lens assembly 300 of the third embodiment corresponding the light having wavelengths of 0.435 μm, 0.480 μm, 0.545 μm, 0.585 μm, and 0.656 μm is within the range of −75%. Hence, the distortion of the wide angle optical lens assembly 300 of the current embodiment could be effectively corrected.

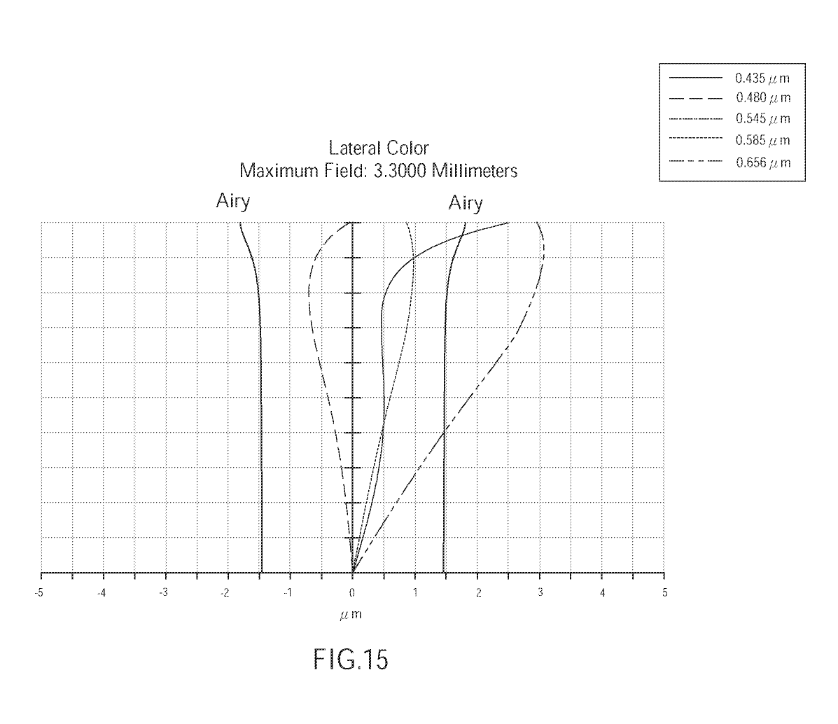

As shown in FIG. 15, the lateral color aberration of the wide angle optical lens assembly 300 of the third embodiment corresponding to the light having wavelengths of 0.435 μm, 0.480 μm, 0.545 μm, 0.585 μm, and 0.656 μm is generally within the range of the Airy disk radius. Hence, the lateral color aberration of the wide angle optical lens assembly 300 of the current embodiment could be effectively corrected.

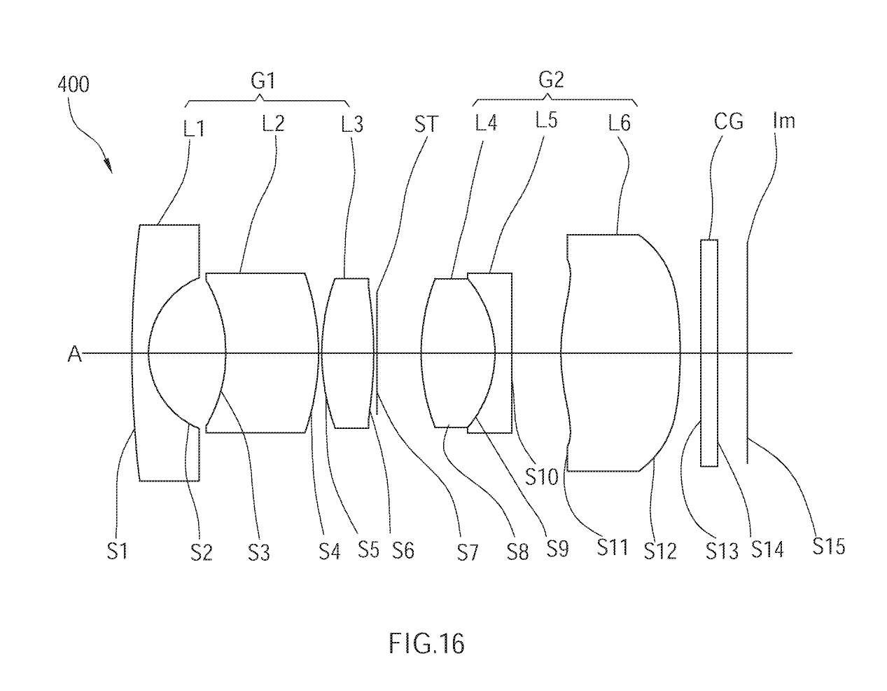

A wide angle optical lens assembly 400 of a fourth embodiment of the present invention is illustrated in FIG. 16, which has almost the same structure as the wide angle optical lens assembly 100 of the first embodiment, wherein the wide angle optical lens assembly 400 of the fourth embodiment includes a first lens group G1 and a second lens group G2 arranged in order from an object side to an image plane Im along an optical axis A.

In the current embodiment, an effective focal length of the first lens group G1 is positive. The first lens group G1 includes a first lens L1, a second lens L2, and a third lens L3, which are arranged in order from the object side to the image plane Im along the optical axis A, wherein the first lens L1 has negative refractive power, the second lens L2 has negative refractive power, and the third lens L3 has positive refractive power. In the current embodiment, the first lens L1 is a meniscus lens, having a convex surface S1 facing the object side and a concave surface S2 facing the image plane Im; the second lens L2 is a meniscus lens, having a concave surface S3 facing the object side and a convex surface S4 facing the image plane Im; the third lens L3 is a biconvex lens.

In the current embodiment, an effective focal length of the second lens group G2 is positive. The second lens group G2 includes a fourth lens L4, a fifth lens L5, and a sixth lens L6, which are arranged in order from the object side to the image plane Im along the optical axis A, wherein the fourth lens L4 has positive refractive power, the fifth lens L5 has negative refractive power, and the sixth lens L6 has positive refractive power. In the current embodiment, the fourth lens L4 is a biconvex lens; the fifth lens L5 is a biconcave lens, having a concave surface S9 facing the object side, i.e, an object-side surface, and a concave surface S10 facing the image plane Im, i.e, an image-side surface; the sixth lens L6 is a biconvex lens. The object-side surface of the fifth lens L5 and an image-side surface of the fourth lens L4 are adhered together to form a doublet lens. In the current embodiment, both the object-side surface and the image-side surface of the sixth lens L6 are aspheric. The sixth lens L6 is a molded aspheric lens, whereby to reduce the aberration of the wide angle optical lens assembly 400, and the number of the lens elements can be reduced so as to minimize the total track length thereof. In addition, a stop ST can be disposed between the first lens group G1 and the second lens group G2, and a filter CG can be disposed between the sixth lens L6 and the image plane Im.

Said wide angle optical lens assembly 400 of the fourth embodiment further satisfies the following condition: 2.0≤|F1/EFL|≤3.65; 2.6≤|F2/EFL|≤3.45. Preferably, the wide angle optical lens assembly 400 of the fourth embodiment satisfies the following condition: 2.2≤|F1/EFL|≤3.0; 2.8≤|F2/EFL|≤3.15; where EFL is an effective focal length of the wide angle optical lens assembly 400, F1 is the effective focal length of the first lens group G1, F2 is the effective focal length of the second lens group G2. With the aforementioned design, the wide angle optical lens assembly 400 could have a wide angle of view, could be made with a small size, and could be lightweight, of which the total length is short. Preferably, said wide angle optical lens assembly 400 of the fourth embodiment further satisfies the following condition: Nd4<1.5; Vd4>70; Nd5>1.7; Vd5<35; where Nd4 is a refractive index of the fourth lens L4, Vd4 is a dispersion coefficient of the fourth lens L4; Nd5 is a refractive index of the fifth lens L5, Vd5 is a dispersion coefficient of the fifth lens L5. With the aforementioned design regarding the refractive indexes Nd4, Nd5 and the dispersion coefficients Vd4, Vd5 of the fourth lens L4 and the fifth lens L5, the longitudinal chromatic aberration of the wide angle optical lens assembly 400 could be further minimized, providing a better performance balance.

The parameters of the lenses of the wide angle optical lens assembly 400 of the fourth embodiment of the present invention are shown in Table 7, wherein F1=6.673 mm; F2=9.555 mm; EFL=3.033 mm; F-number=2.0; TTL=18.5 mm; F 1/EFL=2.2001; F2/EFL=3.1503; where TTL is the total track length of the wide angle optical lens assembly 400 (i.e., a distance on the optical axis A from the surface S1 of the first lens L1 which faces the object side to the image plane Im); the units of the curvature radius, the thickness, the distance and the focal length are expressed in mm; surfaces 0 to S15 respectively represents the surfaces of the lenses in order from the object side to the image plane Im.

TABLE 7
Fourth embodiment

| | | | | Refrac- | | |
|---|---|---|---|---|---|---|
| | | Radius of | Thick- | tive | Abbe | Focal |
| | | curvature | ness | index, | number, | Length |
| | Suface# | (mm) | (mm) | Nd | Vd | (mm) |
| Object | 0 | Plano | Infinity | | | |
| L1 | S1 | 32.003 | 0.500 | 1.651 | 56.2 | −4.085 |
| | S2 | 2.450 | 2.321 | | | |
| L2 | S3 | −4.348 | 2.786 | 1.772 | 49.6 | −25.145 |
| | S4 | −7.161 | 0.100 | | | |
| L3 | S5 | 6.544 | 1.557 | 1.743 | 49.3 | 6.005 |
| | S6 | −12.802 | 0.100 | | | |
| STOP | S7 | Plano | 1.331 | | | |
| L4 | S8 | 6.152 | 2.218 | 1.497 | 81.6 | 4.810 |
| L5 | S9 | −3.458 | 0.500 | 1.752 | 25.0 | −4.513 |
| | S10 | 408.581 | 1.482 | | | |
| L6 | S11 | 5.724(ASP) | 3.579 | 1.496 | 81.6 | 9.265 |
| | S12 | −18.940(ASP) | 0.630 | | | |
| CG | S13 | Plano | 0.500 | 1.516 | 64.1 | — |
| | S14 | Plano | 0.900 | | | |
| Image | S15 | Plano | — | | | |

The aspheric coefficients of each of the lenses of the wide angle optical lens assembly 400 of the fourth embodiment of the present invention are shown in Table 8; where K is the conic coefficient of the equation of the aspheric surface profile; A4 to A10 are aspheric coefficients of each of the surfaces of the sixth lens L6.

TABLE 8
Aspheric Coefficients

Surface#

| | S1 | S2 |
|---|---|---|
| K = | −1.02924E+01 | 2.00000E+01 |
| A4 = | 1.22994E−03 | −2.68404E−03 |
| A6 = | −8.67434E−04 | −3.77262E−04 |
| A8 = | 6.64387E−05 | 2.26760E−05 |
| A10 = | −6.66658E−06 | −5.81172E−07 |

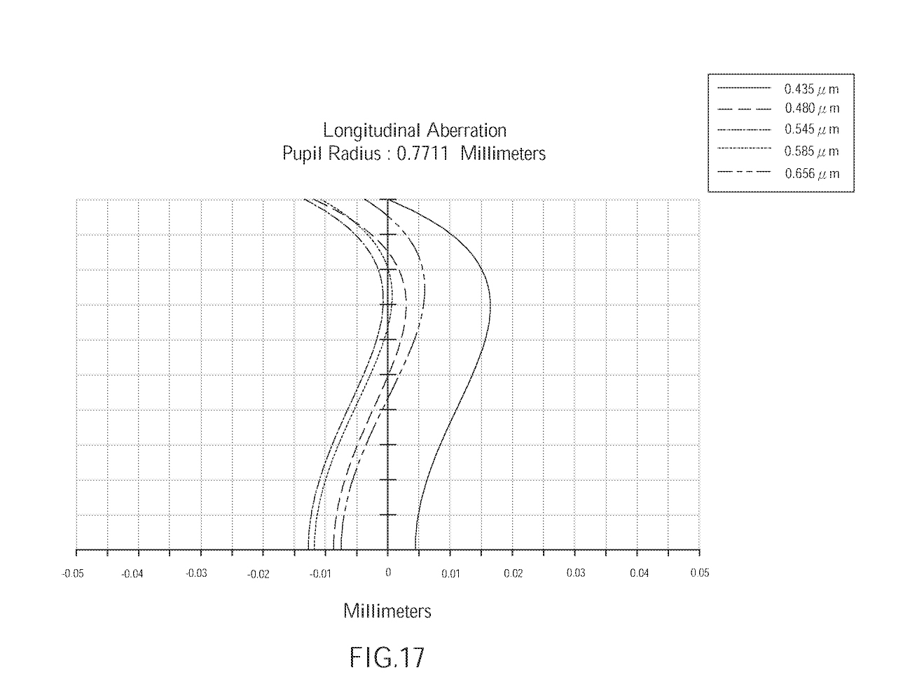

FIG. 17 to FIG. 20 are diagrams showing longitudinal spherical aberration, astigmatic field curves, distortion, and lateral color aberration of the wide angle optical lens assembly 400 of the fourth embodiment of the present invention.

As shown in FIG. 17, the longitudinal spherical aberration of the wide angle optical lens assembly 400 of the fourth embodiment corresponding to the light having wavelengths of 0.435 μm, 0.480 μm, 0.545 μm, 0.585 μm, and 0.656 μm is within a range of −0.015 mm to 0.02 mm. Hence, in the current embodiment, the longitudinal spherical aberration of the lens assembly is improved.

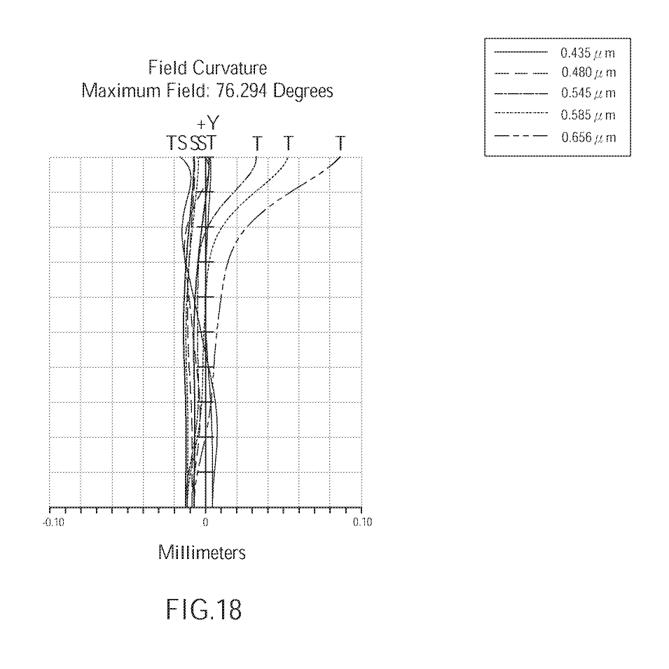

As shown in FIG. 18, the field curvature of the wide angle optical lens assembly 400 of the fourth embodiment corresponding to the light having wavelengths of 0.435 μm, 0.480 μm, 0.545 μm, 0.585 μm, and 0.656 μm in the tangential direction and the sagittal direction is respectively within a range of −0.02 mm to 0.08 mm Hence, in the current embodiment, the astigmatic can be effectively corrected.

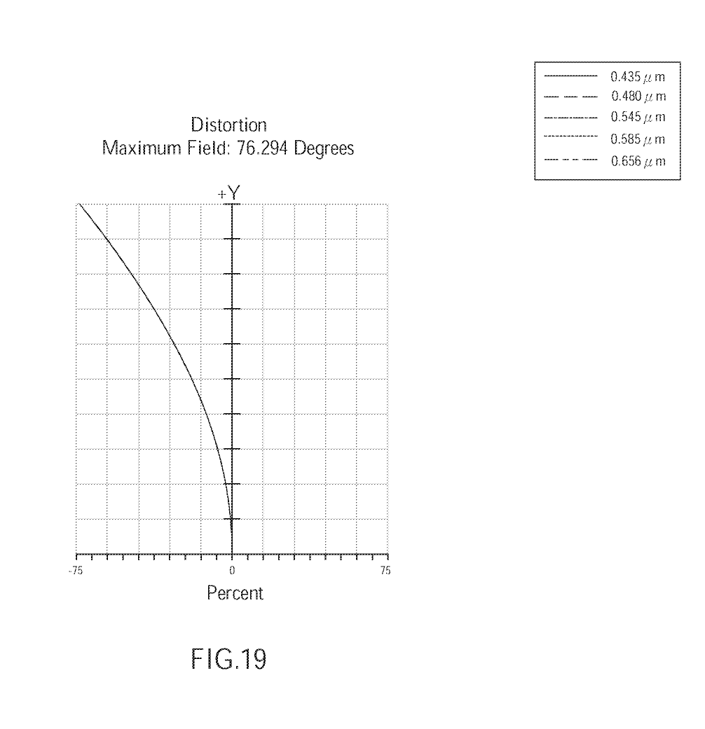

As shown in FIG. 19, the distortion of the wide angle optical lens assembly 400 of the fourth embodiment corresponding the light having wavelengths of 0.435 μm, 0.480 μm, 0.545 μm, 0.585 μm, and 0.656 μm is within the range of −75%. Hence, the distortion of the wide angle optical lens assembly 400 of the current embodiment could be effectively corrected.

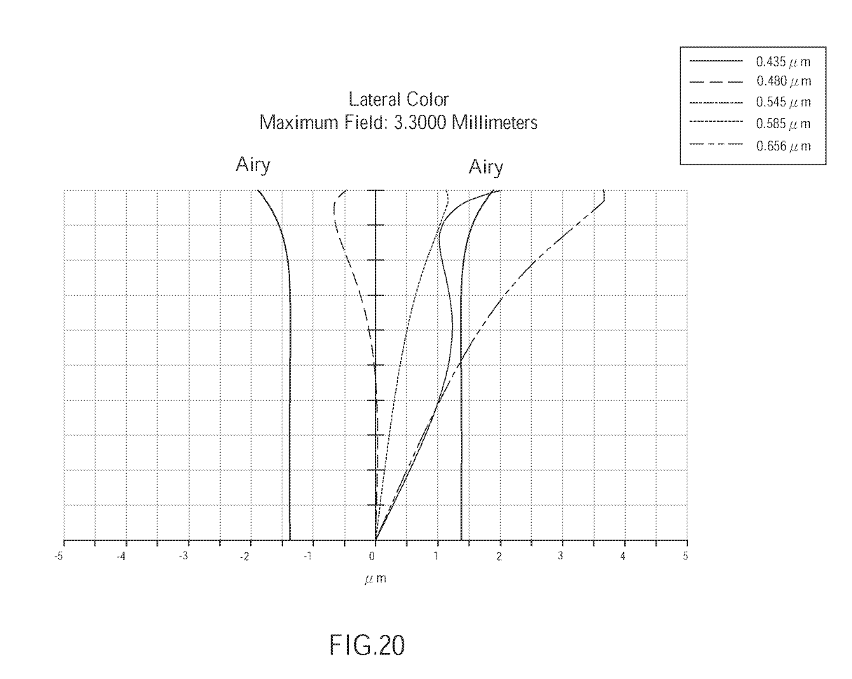

As shown in FIG. 20, the lateral color aberration of the wide angle optical lens assembly 400 of the fourth embodiment corresponding to the light having wavelengths of 0.435 μm, 0.480 μm, 0.545 μm, 0.585 μm, and 0.656 μm is generally within the range of the Airy disk radius. Hence, the lateral color aberration of the wide angle optical lens assembly 400 of the current embodiment could be effectively corrected.

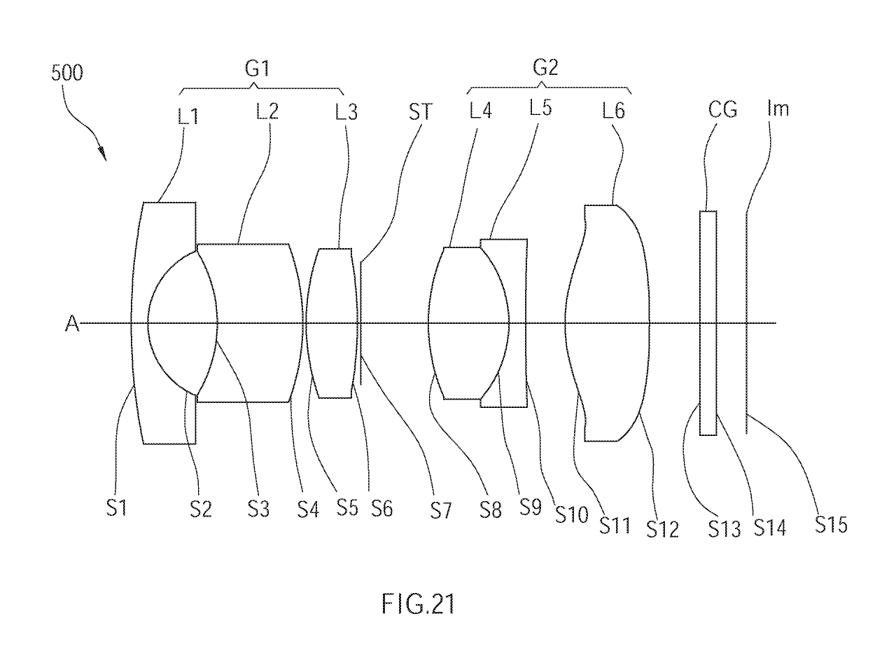

A wide angle optical lens assembly 500 of a fifth embodiment of the present invention is illustrated in FIG. 21, which has almost the same structure as the wide angle optical lens assembly 100 of the first embodiment, wherein the wide angle optical lens assembly 500 of the fifth embodiment includes a first lens group G1 and a second lens group G2 arranged in order from an object side to an image plane Im along an optical axis A.

In the current embodiment, an effective focal length of the first lens group G1 is positive. The first lens group G1 includes a first lens L1, a second lens L2, and a third lens L3, which are arranged in order from the object side to the image plane Im along the optical axis A, wherein the first lens L1 has negative refractive power, the second lens L2 has negative refractive power, and the third lens L3 has positive refractive power. In the current embodiment, the first lens L1 is a meniscus lens, having a convex surface S1 facing the object side and a concave surface S2 facing the image plane Im; the second lens L2 is a meniscus lens, having a concave surface S3 facing the object side and a convex surface S4 facing the image plane Im; the third lens L3 is a biconvex lens.

In the current embodiment, an effective focal length of the second lens group G2 is positive. The second lens group G2 includes a fourth lens L4, a fifth lens L5, and a sixth lens L6, which are arranged in order from the object side to the image plane Im along the optical axis A, wherein the fourth lens L4 has positive refractive power, the fifth lens L5 has negative refractive power, and the sixth lens L6 has positive refractive power. In the current embodiment, the fourth lens L4 is a biconvex lens; the fifth lens L5 is a biconcave lens, having a concave surface S9 facing the object side, i.e, an object-side surface, and a concave surface S10 facing the image plane Im, i.e, an image-side surface; the sixth lens L6 is a biconvex lens. The object-side surface of the fifth lens L5 and an image-side surface of the fourth lens L4 are adhered together to form a doublet lens. In the current embodiment, both the object-side surface and the image-side surface of the sixth lens L6 are aspheric. The sixth lens L6 is a molded aspheric lens, whereby to reduce the aberration of the wide angle optical lens assembly 500, and the number of the lens elements can be reduced so as to minimize the total track length thereof. In addition, a stop ST can be disposed between the first lens group G1 and the second lens group G2, and a filter CG can be disposed between the sixth lens L6 and the image plane Im.

Said wide angle optical lens assembly 500 of the fifth embodiment further satisfies the following condition: 2.0≤|F1/EFL|≤3.65; 2.6≤|F2/EFL|≤3.45. Preferably, the wide angle optical lens assembly 500 of the fifth embodiment satisfies the following condition: 2.2≤|F1/EFL|≤3.0; 2.8≤|F2/EFL|≤3.15; where EFL is an effective focal length of the wide angle optical lens assembly 500, F1 is the effective focal length of the first lens group G1, F2 is the effective focal length of the second lens group G2. With the aforementioned design, the wide angle optical lens assembly 500 could have a wide angle of view, could be made with a small size, and could be lightweight, of which the total length is short. Preferably, said wide angle optical lens assembly 500 of the fifth embodiment further satisfies the following condition: Nd4<1.5; Vd4>70; Nd5>1.7; Vd5<35; where Nd4 is a refractive index of the fourth lens L4, Vd4 is a dispersion coefficient of the fourth lens L4; Nd5 is a refractive index of the fifth lens L5, Vd5 is a dispersion coefficient of the fifth lens L5. With the aforementioned design regarding the refractive indexes Nd4, Nd5 and the dispersion coefficients Vd4, Vd5 of the fourth lens L4 and the fifth lens L5, the longitudinal chromatic aberration of the wide angle optical lens assembly 500 could be further minimized, providing a better performance balance.

The parameters of the lenses of the wide angle optical lens assembly 500 of the fifth embodiment of the present invention are shown in Table 9, wherein F1=8.787 mm; F2=8.239 mm; EFL=2.929 mm; F-number=2.0; TTL=18.5 mm; F 1/EFL=3.0000; F2/EFL=2.8129; where TTL is the total track length of the wide angle optical lens assembly 500 (i.e., a distance on the optical axis A from the surface S1 of the first lens L1 which faces the object side to the image plane Im); the units of the curvature radius, the thickness, the distance and the focal length are expressed in mm; surfaces 0 to S15 respectively represents the surfaces of the lenses in order from the object side to the image plane Im.

TABLE 9
Fifth embodiment

| | | | | Refrac- | | |
|---|---|---|---|---|---|---|
| | | Radius of | Thick- | tive | Abbe | Focal |
| | | curvature | ness | index, | number, | Length |
| | Suface# | (mm) | (mm) | Nd | Vd | (mm) |
| Object | 0 | Plano | Infinity | | | |
| L1 | S1 | 18.021 | 0.500 | 1.744 | 44.9 | −3.671 |
| | S2 | 2.354 | 2.091 | | | |
| L2 | S3 | −4.122 | 2.570 | 1.772 | 49.6 | −23.813 |
| | S4 | −6.751 | 0.100 | | | |
| L3 | S5 | 6.649 | 1.542 | 1.700 | 48.1 | 6.171 |
| | S6 | −11.313 | 0.104 | | | |
| STOP | S7 | Plano | 2.029 | | | |
| L4 | S8 | 5.506 | 2.421 | 1.496 | 81.6 | 4.691 |
| L5 | S9 | −3.470 | 0.500 | 1.784 | 26.1 | −4.162 |
| | S10 | 70.210 | 1.185 | | | |
| L6 | S11 | 4.463(ASP) | 2.544 | 1.496 | 81.6 | 7.415 |
| | S12 | −17.437(ASP) | 1.518 | | | |
| CG | S13 | Plano | 0.500 | 1.516 | 64.1 | — |
| | S14 | Plano | 0.900 | | | |
| Image | S15 | Plano | — | | | |

The aspheric coefficients of each of the lenses of the wide angle optical lens assembly 500 of the fifth embodiment of the present invention are shown in Table 10; where K is the conic coefficient of the equation of the aspheric surface profile; A4 to A10 are aspheric coefficients of each of the surfaces of the sixth lens L6.

TABLE 10
Aspheric Coefficients

Surface#

| | S1 | S2 |
|---|---|---|
| K = | −5.94436E+00 | 2.00000E+01 |
| A4 = | 3.44278E−03 | −9.26529E−05 |
| A6 = | −6.96556E−04 | −1.67531E−04 |
| A8 = | 5.04009E−05 | −3.53288E−06 |
| A10 = | −3.43959E−06 | −3.78290E−08 |

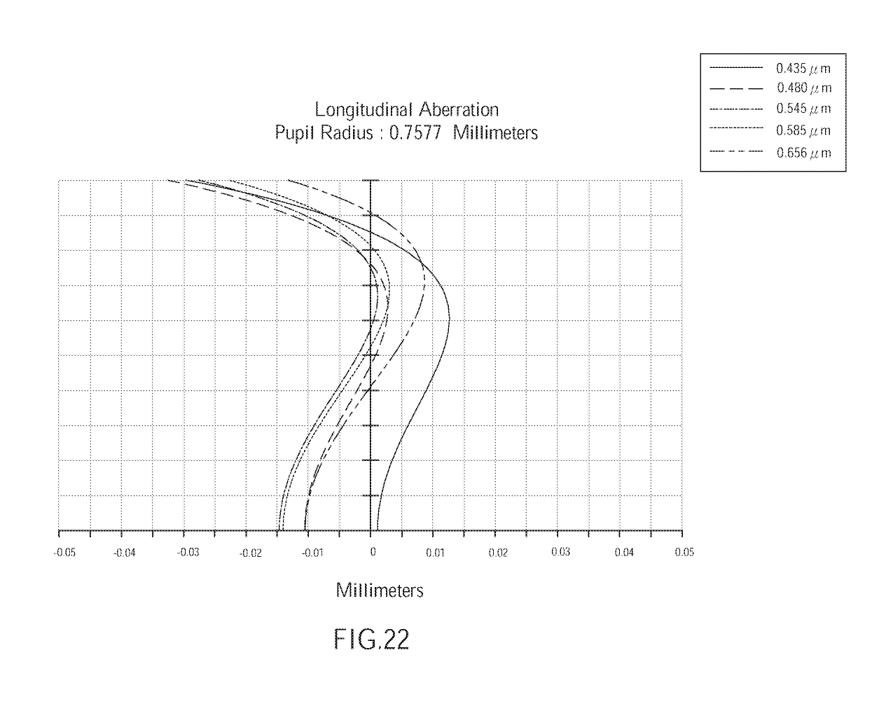

FIG. 22 to FIG. 25 are diagrams showing longitudinal spherical aberration, astigmatic field curves, distortion, and lateral color aberration of the wide angle optical lens assembly 500 of the fifth embodiment of the present invention.

As shown in FIG. 22, the longitudinal spherical aberration of the wide angle optical lens assembly 500 of the fifth embodiment corresponding to the light having wavelengths of 0.435 μm, 0.480 μm, 0.545 μm, 0.585 μm, and 0.656 μm is within a range of −0.035 mm to 0.015 mm Hence, in the current embodiment, the longitudinal spherical aberration of the lens assembly is improved.

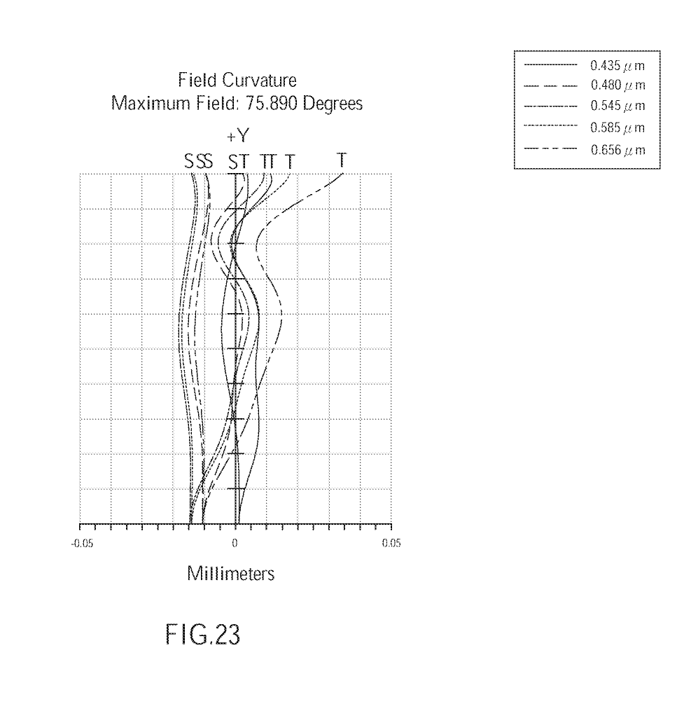

As shown in FIG. 23, the field curvature of the wide angle optical lens assembly 500 of the fifth embodiment corresponding to the light having wavelengths of 0.435 μm, 0.480 μm, 0.545 μm, 0.585 μm, and 0.656 μm in the tangential direction and the sagittal direction is respectively within a range of −0.02 mm to 0.04 mm Hence, in the current embodiment, the astigmatic can be effectively corrected.

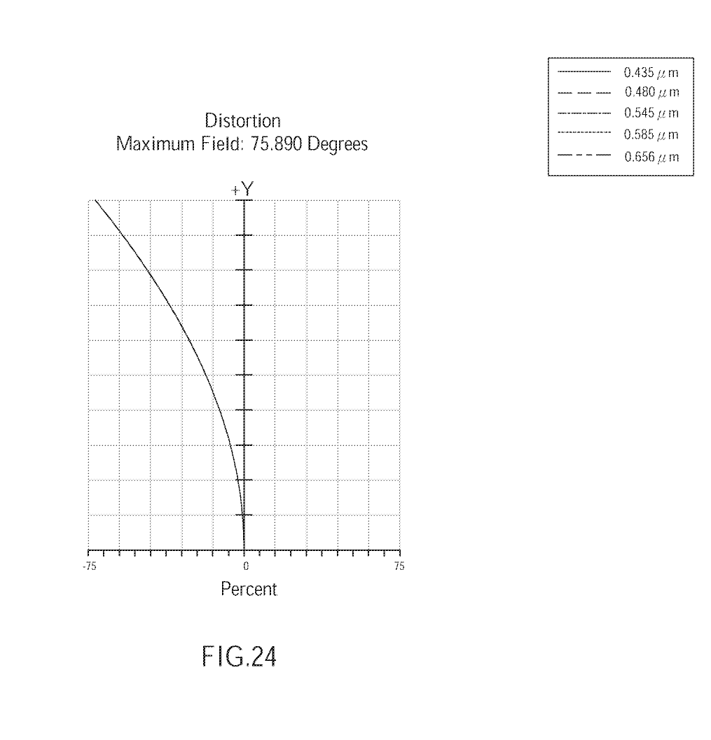

As shown in FIG. 24, the distortion of the wide angle optical lens assembly 500 of the fifth embodiment corresponding the light having wavelengths of 0.435 μm, 0.480 μm, 0.545 μm, 0.585 μm, and 0.656 μm is within the range of −75%. Hence, the distortion of the wide angle optical lens assembly 500 of the current embodiment could be effectively corrected.

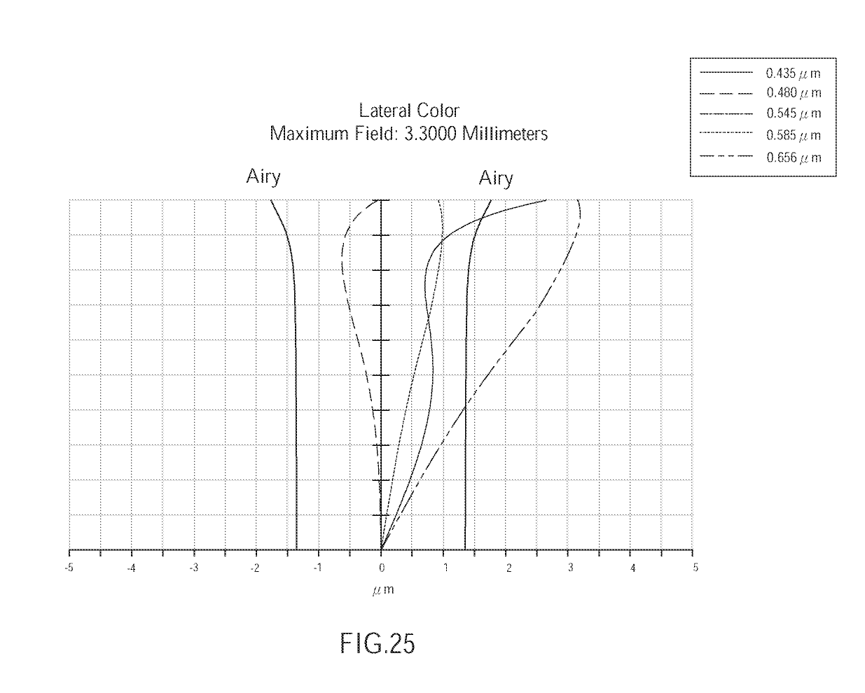

As shown in FIG. 25, the lateral color aberration of the wide angle optical lens assembly 500 of the fifth embodiment corresponding to the light having wavelengths of 0.435 μm, 0.480 μm, 0.545 μm, 0.585 μm, and 0.656 μm is generally within the range of the Airy disk radius. Hence, the lateral color aberration of the wide angle optical lens assembly 500 of the current embodiment could be effectively corrected.

In summary, with the aforementioned design, especially the conditions of 2.0≤|F1/EFL|≤3.65; 2.6≤|F2/EFL|≤3.45; or 2.2≤|F1/EFL|≤3.0; 2.8≤|F2/EFL|≤3.15, etc., the wide angle optical lens assembly of the present invention could provide a wide angle of view, could be made with a small size, and could be lightweight, of which the total length is short.

It must be pointed out that the embodiments described above are only some embodiments of the present invention. All equivalent structures which employ the concepts disclosed in this specification and the appended claims should fall within the scope of the present invention.

What is claimed is:

1. A wide angle optical lens assembly, comprising, in order from an object side to an image plane along an optical axis:
a first lens group, which comprises a first lens, a second lens, and a third lens arranged in order from the object side to the image plane along the optical axis, wherein the first lens has negative refractive power; the second lens has negative refractive power, and is a meniscus lens, having a convex surface facing the image plane; the third lens has positive refractive power; and
a second lens group, which comprises a fourth lens, a fifth lens, and a sixth lens arranged in order from the object side to the image plane along the optical axis, wherein the fourth lens has positive refractive power, the fifth lens has negative refractive power, and the sixth lens has positive refractive power;
wherein the wide angle optical lens assembly satisfies the following condition:
2.0≤|F1/EFL|≤3.65;
2.6≤|F2/EFL|≤3.45;
where EFL is an effective focal length of the wide angle optical lens assembly, F1 is the effective focal length of the first lens group, and F2 is the effective focal length of the second lens group.

2. The wide angle optical lens assembly of claim 1, wherein the first lens is a meniscus lens, having a convex surface facing the object side.

3. The wide angle optical lens assembly of claim 1, wherein the fifth lens is a biconcave lens.

4. The wide angle optical lens assembly of claim 1, wherein at least one of two surfaces of the sixth lens is aspheric.

5. The wide angle optical lens assembly of claim 4, wherein both the surfaces of the sixth lens facing the object side and the image plane are aspheric.

6. The wide angle optical lens assembly of claim 1, wherein an effective focal length of the first lens group is positive, and an effective focal length of the second lens group is positive.

7. The wide angle optical lens assembly of claim 1, further satisfying the following condition:
Nd4<1.5;
Vd4>70;
where Nd4 is a refractive index of the fourth lens, and Vd4 is a dispersion coefficient of the fourth lens.

8. The wide angle optical lens assembly of claim 1, further satisfying the following condition:
Nd5>1.7;
Vd5<35;
where Nd5 is a refractive index of the fifth lens, and Vd5 is a dispersion coefficient of the fifth lens.

9. The wide angle optical lens assembly of claim 1, further comprising a stop disposed between the first lens group and the second lens group.

10. The wide angle optical lens assembly of claim 1, further satisfying the following condition:
2.2≤|F1/EFL|≤3.0;
2.8≤|F2/EFL|≤3.15.

11. The wide angle optical lens assembly of claim 1, wherein the fifth lens and the fourth lens are adhered together to form a doublet lens.
